(19) United States
(12) Patent Application Publication
(10) Pub. No.: US 2026/0203104 A1
(43) Pub. Date: Jul. 16, 2026

(54) AUTOMATED NODE MODIFICATION IN COMPUTING CLUSTERS

(71) Applicant: NVIDIA Corporation, Santa Clara, CA (US)

(72) Inventors: Alex Daniel Yuskauskas, Portland, OR (US); Brian Robert Lockwood, Olympia, WA (US)

(21) Appl. No.: 19/263,293

(22) Filed: Jul. 8, 2025

Related U.S. Application Data
(60) Provisional application No. 63/745,233, filed on Jan. 14, 2025.

(51) Int. Cl. G06F 9/48; G06F 9/50; G06F 11/30

(52) U.S. Cl. CPC G06F 9/4881; G06F 9/5027; G06F 11/3006; G06F 11/3055; G06F 2209/505; G06F 2209/508

(57) ABSTRACT

Systems and methods are provided for automatically modifying nodes in a computing cluster while maintaining workload continuity in the computing cluster. At least one embodiment relates to an operator that coordinates with a cluster manager to monitor nodes of the computing cluster, apply modifications to the nodes of the computing cluster, and schedule workloads for the nodes of the computing cluster based on a custom resource.

### PRIORITY CLAIM

This application claims the benefit of U.S. Provisional Patent Application Ser. No. 63/745,233, filed on Jan. 14, 2025, titled “SKYHOOK, A KUBERNETES NATIVE PACKAGE MANAGER,” the contents of which are incorporated by reference herein in its entirety.

### TECHNICAL FIELD

The present disclosure relates to distributed computing systems. In at least one embodiment, the present disclosure relates to managing nodes in distributed computing systems.

### BACKGROUND

A computing cluster is a group of interconnected computing systems that work together to function like a single computing system. Each interconnected computing system is a separate computing system running its own operating system. The functions performed by each interconnected computing systems are centrally managed and coordinated so that the computing cluster may be presented as a single computing resource. This architecture enables the computing cluster to deliver scalable processing power with improved reliability compared to individual computing systems. Computing clusters are used in various industries for their ability to perform complicated computational tasks by distributing them across multiple computing systems. For example, computing clusters are used in scientific research, data analytics, and artificial intelligence (AI) training. However, as computing clusters become more widespread, and the computational tasks they perform become more complicated, various technical challenges arise that impact the ability for these computing clusters to deliver scalable and reliable processing power.

### BRIEF DESCRIPTION OF THE DRAWINGS

The accompanying drawings are provided for purposes of illustration and not limitation. In the drawings, which are not necessarily drawn to scale, like numerals may describe similar components in different views.

FIG. 1 is a block diagram illustrating an example custom resource, according to at least one embodiment;

FIG. 2 is a block diagram illustrating an example system, according to at least one embodiment;

FIG. 3 is a block diagram illustrating an example system, according to at least one embodiment;

FIG. 4 is a flow diagram illustrating an example method for applying a modification involving an interrupt, according to at least one embodiment;

FIG. 5 is a flow diagram illustrating an example method for monitoring events on a computing cluster, according to at least one embodiment;

FIG. 6 is a flow diagram illustrating an example method for applying packages of a custom resource to a computing cluster, according to at least one embodiment;

FIG. 7 is a flow diagram illustrating an example method for applying a package to a computing cluster, according to at least one embodiment;

FIG. 8 is a flow diagram illustrating an example method for applying a package to a computing cluster, according to at least one embodiment;

FIG. 9 is a flow diagram illustrating an example method for recovering a state of a node, according to at least one embodiment;

FIG. 10 is a timing diagram illustrating an example method performed by an example system, according to at least one embodiment;

FIG. 11 is a flow diagram illustrating an example method, according to at least one embodiment;

FIG. 12 is a block diagram of an example computing device suitable for use in implementing at least some embodiments of the present disclosure; and

FIG. 13 is a block diagram of an example data center suitable for use in implementing at least some embodiments of the present disclosure.

### DETAILED DESCRIPTION

Systems and methods are disclosed related to managing nodes in a distributed computing system, such as a computing cluster. In at least one embodiment, a package manager coordinates with a cluster manager of a computing cluster to automate modification of nodes in the computing cluster while maintaining workload continuity. The package manager uses an operator to communicate with the cluster manager to monitor statuses of the nodes, such as whether the nodes are currently processing a workload or are available for modification. The operator coordinates with the cluster manager to prevent new workloads from being scheduled for the nodes until the modifications have been applied. In at least one embodiment, the operator coordinates with the cluster manager to interrupt a workload being processed on a node before applying the modification to the node. Through communication with the cluster manager, the package manager automatically identifies, in real-time, which nodes are available for modification and which nodes are unavailable. This allows the computing cluster to continue operation instead of, for example, shutting down for a maintenance window to perform modifications.

The operator uses labels to monitor the statuses of the nodes. For example, the package manager provides customized labels that are applied to the nodes to indicate the statuses of the nodes. The labels indicate, for example, that a node is processing a workload, that a node is available, that a node is processing an uninterruptible workload, that a node is processing an interruptible workload, that a node is being modified, and that a node has been modified. The operator uses these labels to coordinate with the cluster manager to apply modifications to the nodes of the computing cluster without disrupting the workloads being processed on the computing cluster. In at least one embodiment, the operator applies labels to nodes to prevent the cluster manager from assigning new workloads to the nodes and removes the labels after applying modifications to the nodes to allow the cluster manager to assign new workloads to the nodes.

In various implementations, labels may include, for example, annotations and taints. For example, in at least one embodiment, a label is a key-value pair used to identify and select objects, such as pods and nodes, for grouping, filtering, and organizing. An annotation is a key-value pair used to store non-identifying, auxiliary metadata. A taint is used on nodes to prevent workloads from being scheduled for the nodes. In at least one embodiment, a label generally refers to labels, annotations, and taints collectively as metadata that is associated with objects in a computing cluster.

A workload, for example, is an application or a service that runs on a node. In at least one embodiment, workloads are assigned and scheduled by the cluster manager to be performed by nodes of the computing cluster. A workload may be a single component to process a computing task, or the workload may be part of several components working together to process a computing task.

The operator applies a modification, such as updates and uninstalls, based on conditions and other instructions specified for the modification. A package including the modification specifies conditions, such as identification of nodes that are to be modified and identification of dependencies for the modification, to facilitate the modification. The operator determines if the conditions for application of the modification to a node are satisfied based on, for example, labels of the node or other information obtained from coordination with the cluster manager. Through use of labels, the package manager maintains information about each node of a computing cluster, which facilitates the correct modifications being applied as well as avoiding errors, such as a workload being scheduled for a node being modified.

A modification, for example, is a change to the software components of a node. For example, modifications include changes to the operating system of a node. These changes include updates to operating systems, installations of operating systems, and uninstalls of operating systems. Modifications include changes to software applications running on the node, such as updates to applications, installs of applications, and uninstalls of applications. Modifications include changes to configurations or parameters of the node, such as changing configuration values of the node.

Modifications are applied to nodes in a manner that does not disrupt the workloads of the computing cluster as the modifications are being applied. For example, when an operator applies a modification to a node, a label is applied to prevent new workloads from being scheduled on the node. The node is drained of its existing workload, and then the modification is applied to node. After the modification is applied, the label is removed from the node, allowing new workloads to be scheduled on the node. Meanwhile, the cluster manager continues to schedule new workloads for other nodes of the computing cluster, allowing the computing cluster to continue to operate while modifications are being applied. As shutting down a computing cluster for a maintenance window represents a significant loss in productivity, being able to continue operate while modifications are being applied improves the overall efficiency of the computing cluster.

In at least one embodiment, modifications are applied based on an interrupt budget. The interrupt budget specifies a threshold percentage of nodes or a threshold number of nodes. The operator coordinates with the cluster manager to interrupt nodes for modification within the threshold percentage or the threshold number. In at least one embodiment, the interrupt budget includes different thresholds for different node types. For example, a control plane node may have a lower threshold than a worker node to maintain stability in the computing cluster. This allows the computing cluster to operate consistently while modifications are being applied by maintaining at least a minimum number of nodes to keep the computing cluster operational.

As new nodes are joined to a computing cluster, the package manager automatically configures the new nodes with appropriate modifications. For example, an operator communicates with a cluster manager to determine when a new node joins a computing cluster. Before the new node joins the computing cluster, the operator coordinates with the cluster manager to apply a label to the new node to prevent workloads from being scheduled for the new node. Applying the label to the new node before the new node joins the computing cluster, prevents workloads from being scheduled for the new node before the label is applied. The operator determines modifications to be applied to the new node based on conditions associated with the modifications. After the modifications are applied, the operator removes the label, and the new node is ready to receive workloads scheduled by the cluster manager. In at least one embodiment, the application of labels to new nodes before the new nodes join the computing cluster is referred to as a runtime-required mode. In the runtime-required mode, nodes have pre-applied labels preventing workloads from being scheduled. When all nodes with the pre-applied labels have successfully been modified, the labels are removed from the nodes so that they are schedulable for new workloads.

In at least one embodiment, a package manager monitors statuses of a set of nodes of a computing cluster. The package manager monitors the statuses by providing queries to a cluster manager of the computing cluster and receiving events indicating changes to the set of nodes. The package manager identifies a node to apply a modification (e.g., update) based on the statuses. The package manager applies a label to the node to prevent new workloads from being scheduled for the node. For example, the label is a “taint” that indicates to the cluster manager to remove the node from the pool of available nodes for new workload scheduling. The package manager applies the modification to the node. For example, the modification is an update to an operating system of the node. Upon completion of the application of the modification to the node, the package manager removes the label from the node. The removal of the label from the node allows the cluster manager to schedule new workloads to the node.

In at least one embodiment, the package manager monitors the statuses of the set of nodes by subscribing to events that occur on the computing cluster. The events are automatically generated each time a change to the computing cluster occurs, such as deployment of a new node, successful completion of a workload, scheduling of a workload, or eviction of a node. The package manager filters the events to surface those that affect the status of the nodes with respect to whether the nodes are available for modification. For example, an operator of the package manager runs a reconciliation loop, or a control loop, to monitor the current state of a computing cluster. As the computing cluster changes, events associated with the changes are filtered by the operator and surfaced when an event related to availability of a node is detected.

In at least one embodiment, the package manager identifies a node to apply a modification based on labels associated with the node. The labels, or annotations, include metadata attached to the node to indicate the current status of the node, such as availability for modifications. For example, the labels indicate a node is available for modifications, a node is assigned to an interruptible workload (e.g., workload that is interruptible without causing data loss or corruption), a node is assigned to an uninterruptible workload (e.g., workload that is uninterruptible without causing data loss or corruption), a node is being modified, and a node has been successfully modified. In at least one embodiment, the labels include annotations indicating which modifications have been applied to the node, providing an update history for the node.

In at least one embodiment, the labels include key-value pairs that the package manager uses to identify a node to apply a modification. The package manager identifies nodes to apply a modification by searching for nodes that satisfy a matching function with respect to the key-value pairs. For example, a matching function specifies a particular key, a particular value, a particular key-value pair, a range of keys, a range of values, or a range of key-value pairs. The matching function specifies that a match includes labels that satisfy the specified keys and/or values or labels that exclude the specified keys and/or values. In at least one embodiment, a combination of matching functions is used to identify a node to apply a modification.

In at least one embodiment, a modification to be applied and the information (e.g., matching functions, interrupt budgets, statuses, dependencies, conditions) associated with applying the modification are stored in an instance of a custom resource. The custom resource provides a declarative specification that specifies a modification to be applied and the conditions for applying the modification. For example, a software package of a custom resource includes a modification, such as an update, a container image, or a script, to be applied. The software package includes environment variables, configuration maps, and other information that the package manager uses to apply the modification to targeted nodes. The package manager identifies nodes that satisfy conditions specified by the custom resource and applies the modification specified in the custom resource to the identified nodes.

In at least one embodiment, one or more software packages are bundled together in a custom resource that facilitates different modifications to different nodes in different situations. For example, a custom resource includes a first package for a first modification that is to be applied to nodes satisfying a set of conditions. The custom resource includes a second package for a second modification that is applied to nodes satisfying the set of conditions. The package manager identifies nodes satisfying the set of conditions to apply the first modification and the second modification. In at least one embodiment, another custom resource may be used to target different nodes with one or more software packages. In at least one embodiment, a first package of a custom resource specifies a second package as a dependency. This dependency specification facilitates deployment scenarios where the second package is to be applied to nodes before the first package is applied. The package manager uses this dependency specification to apply modifications in an appropriate order, ensuring that prerequisites are satisfied before a modification is applied.

In at least one embodiment, the package manager coordinates with the cluster manager to schedule a modification to be applied. For example, the package manager, in communication with the cluster manager, identifies a node to apply a modification and determines that the node is processing an uninterruptible workload. The package manager coordinates with the cluster manager to mark the node as not schedulable for additional workloads so that the node will be available for the modification upon completion of the uninterruptible workload. Upon completion of the workload, the package manager drains the node to evict all data within the node and take the node out of the computing cluster for modification purposes. The modification is applied to the node, and the node is returned to the computing cluster where new workloads are scheduled for the node to process. By coordinating the workload schedule for a node, a modification for the node is automatically applied without disrupting ongoing workloads.

In at least one embodiment, the package manager performs pre-interrupt instructions, interrupt instructions, and post-interrupt instructions as part of a modification to a node. These instructions are specified, for example, in a software package the package manager uses for the modification. For example, a software package for a modification includes pre-interrupt instructions, such as saving state information or executing specified scripts, to execute prior to interrupting a node. The software package includes interrupt instructions, such as a type of interrupt (e.g., reboot interrupt), to execute when interrupting the node. The modification is applied after the node is interrupted. The software package includes post-interrupt instructions, such as cleanup operations or validation checks, to execute after the node is interrupted and the modification is applied. Through these pre-interrupt instructions, interrupt instructions, and post-interrupt instructions, a node is appropriately prepared for a modification, and the node is verified upon application of the modification.

In at least one embodiment, modifying a node includes uninstalling an update or removing a previously installed component from the node. Modifications to a node are recorded as labels or annotations associated with the node. The annotations include, for example, a history of modifications that have been applied to the node. Using the annotations, a package manager executes a software package to uninstall a modification from nodes of a computing cluster. The package manager identifies the nodes from which to uninstall the modification based on the annotations associated with the nodes. After the modification is uninstalled from the nodes, the annotations associated with the nodes are updated to indicate that the modification has been uninstalled.

As the package manager facilitates modifications to nodes of a computing cluster while other nodes of the computing cluster continue processing workloads, the computing cluster continues to schedule and process new workloads even as the nodes in the computing cluster are interrupted and modified. This capacity for modifications of nodes and processing of workloads to occur in parallel allows the computing cluster to avoid downtimes that would hinder the efficiency of the computing cluster.

In at least one embodiment, a custom resource provides a priority (e.g., non-negative integer) that indicates a sequence the custom resource is to be executed relative to other custom resources. For example, a first custom resource with a priority of 0 is executed before a second custom resource with a priority of 1. In at least one embodiment, custom resources with the same priority are executed in an order based on names associated with the custom resources. This allows custom resources to be executed in a consistent, predictable, and repeatable sequence.

In at least one embodiment, a custom resource provides control parameters that control application of the custom resource and other custom resources. For example, a disable control parameter stops a custom resource from being applied. A pause control parameter stops a custom resource and other custom resources with lower priorities from being applied. These control parameters are altered or modified to control execution of the custom resource.

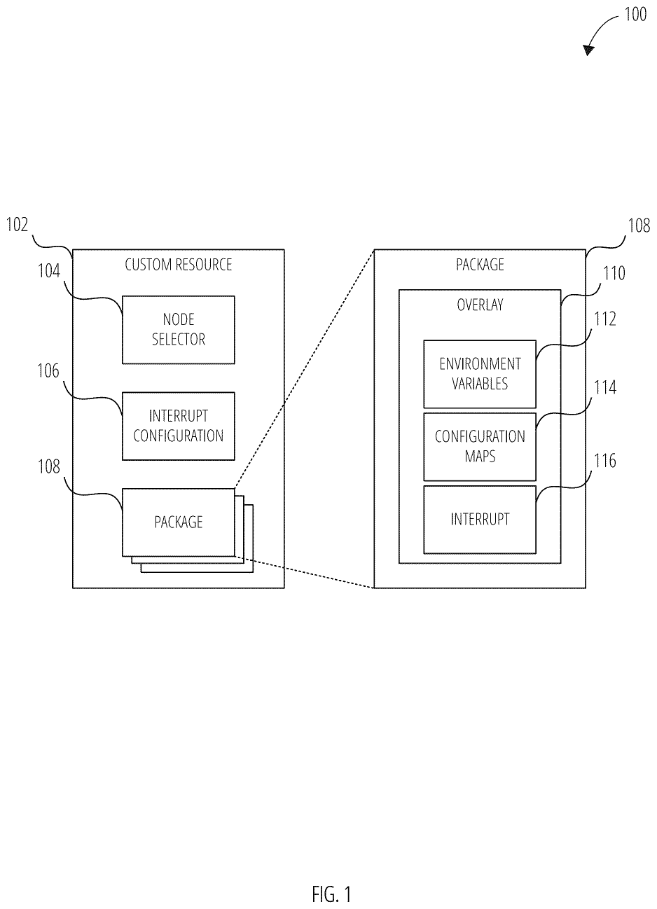

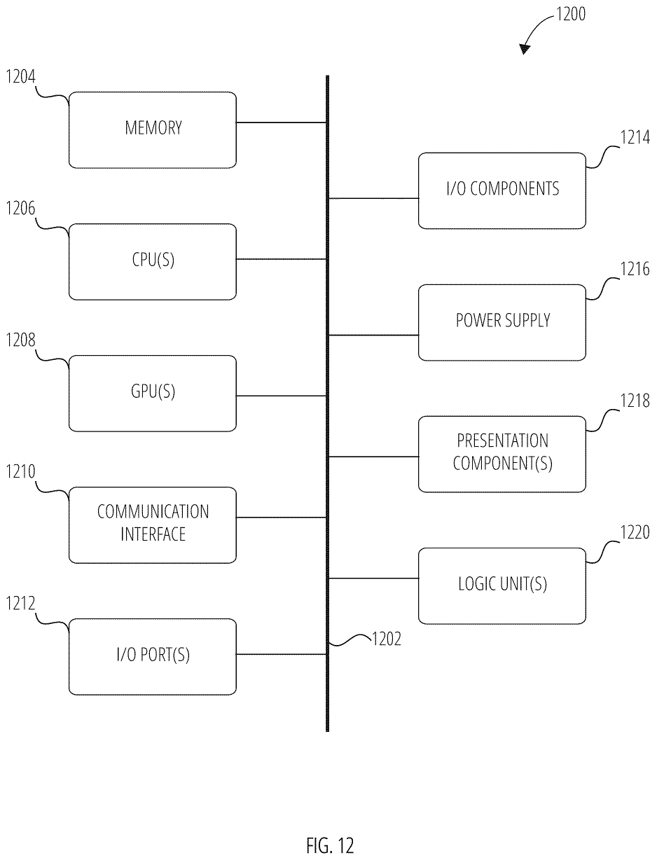

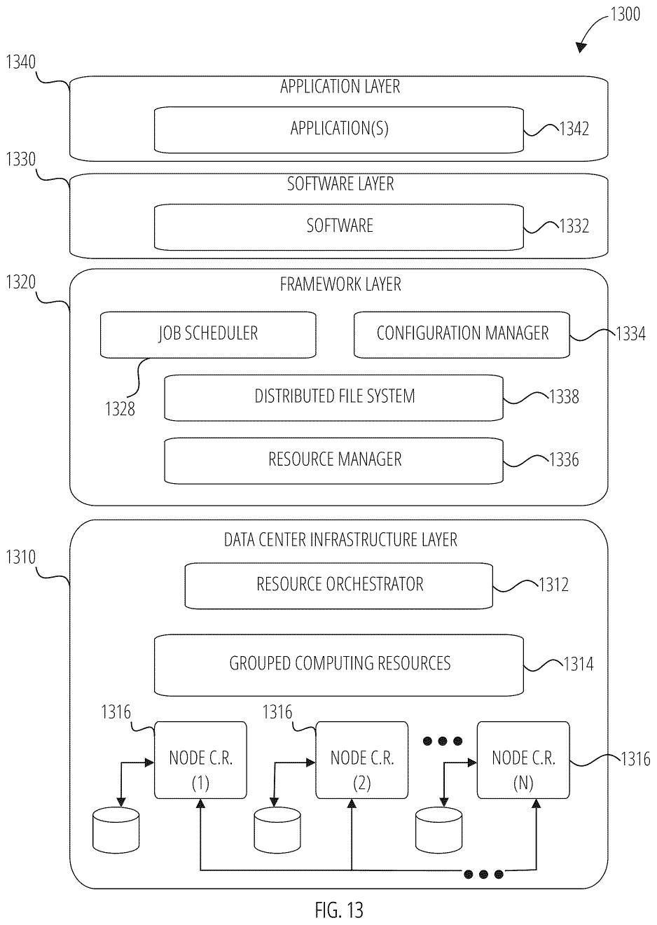

FIG. 1 is a block diagram illustrating an example 100 of a custom resource 102, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in at least one embodiment, the system and methods described herein may be implemented using one or more computing devices or components thereof (e.g., as described in FIG. 12) and/or one or more data centers or components thereof (e.g., as described in FIG. 13).

In FIG. 1, a custom resource 102 serves as a configuration interface for managing node modifications to a computing cluster. The custom resource 102 facilitates the definition and management of modifications to be applied to nodes of a computing cluster and the conditions for application of the modifications. In at least one embodiment, an operator utilizes the information in the custom resource 102 to identify the nodes in the computing cluster to apply the modifications. As illustrated in FIG. 1, the custom resource 102 includes a node selector 104, an interrupt configuration 106, and a package 108.

In at least one embodiment, the custom resource 102 includes flags to control application of modifications provided through the custom resource 102. The flags include, for example, priority flags, toleration flags, and runtime flags. Priority flags indicate a sequence in which custom resources are to be applied. For example, a priority flag indicates that modifications provided by another custom resource are to be applied before the modifications in the custom resource 102 are to be applied. For example, a priority flag indicates a sequence in which the packages of the custom resource 102 are applied. Toleration flags indicate labels that are tolerated for application of modifications. For example, a toleration flag indicates that nodes with, for example, labels indicating a nonoperative node or a broken node, can have the modifications provided by the custom resource 102 applied. Runtime flags indicate whether the modifications provided by the custom resource 102 are to be completed before allowing work to be scheduled for the node. For example, a runtime flag indicates that a node joining a computing cluster is to have the modifications provided by the custom resource completely applied before joining the computing cluster and having work scheduled for the node.

The node selector 104 operates as a targeting mechanism to identify which nodes within a computing cluster to apply a modification in the custom resource 102. For example, the node selector 104 uses matching functions to identify and select nodes from the computing cluster based on conditions specified for the modification. In at least one embodiment, the node selector 104 uses matching functions that compare specified key-value pairs with labels associated with the nodes of the computing cluster. The node selector 104 supports various matching functions to provide flexibility in node targeting. For example, matching functions can specify exact key-value pair matches, presence of specific keys, presence of specific values, exclusion of specific keys, exclusion of specific values, ranges of keys, or ranges of values. The node selector 104 accommodates multiple matching functions simultaneously, identifying nodes that satisfy all specified conditions based on the matching functions.

In at least one embodiment, the node selector 104 dynamically and adaptively targets nodes as a computing cluster changes. For example, as new nodes are added to the computing cluster, or as labels of existing nodes on the computing cluster are modified, the node selector 104 evaluates the labels of the new nodes and the existing nodes to determine if these nodes satisfy the conditions for applying a modification. Through dynamically and adaptively targeting nodes, the node selector 104 automatically identifies the appropriate nodes for a modification based on the conditions associated with the modification.

The interrupt configuration 106 operates as a control mechanism to manage application of modifications to nodes of a computing cluster. The interrupt configuration 106 provides parameters for coordinating interruptions of nodes in the computing cluster without disrupting the overall operation of the computing cluster. For example, the interrupt configuration 106 provides parameters that facilitate identification of interruptible workloads (e.g., workload that is interruptible without causing data loss or corruption) and uninterruptible workloads (e.g., workload that is uninterruptible without causing data loss or corruption). These parameters include, for example, labels identifying nodes performing uninterruptible workloads. In at least one embodiment, nodes without labels identifying the nodes as performing uninterruptible workloads are identified as performing interruptible workloads. In at least one embodiment, a set of predetermined labels is employed, and a determination of which workloads are interruptible and which workloads are uninterruptible is based on matching labels associated with nodes with a definition in a custom resource that identifies which labels identify uninterruptible workloads. In at least one embodiment, labels are employed to identify nodes as not schedulable to prevent additional workloads from being scheduled for the nodes.

In at least one embodiment, the interrupt configuration 106 provides an interruption budget for application of a modification. The interruption budget specifies a maximum threshold of nodes that can be interrupted simultaneously within a computing cluster. This maximum threshold is expressed, for example, as a number of nodes or as a percentage of nodes in the computing cluster. In at least one embodiment, the interruption budget corresponds with a node type. For example, control plane nodes and worker nodes in a computing cluster have respective interruption budgets that specify the respective maximum thresholds for interruption. This provides for precise control over interruption of nodes in the computing cluster, allowing the computing cluster to continue to operate while modifications are applied to the nodes.

In at least one embodiment, the interruption configuration 106 specifies interruption types based on modifications to be deployed. For example, a first modification is associated with a first interruption type, such as a node reboot. This specifies that interrupting a node to apply the first modification involves rebooting the node. A second modification is associated with a second interruption type, such as a service restart. This specifies that interrupting a node to apply the second modification involves restarting services on the node. A third modification is associated with a third interruption type, such as a no operation interrupt. This specifies that interrupting a node to apply the third modification does not involve a node reboot or a service restart. These interruption instructions allow for nodes to be in an appropriate state when a modification is applied so that the modification is applied correctly and so that the node is ready for processing workloads after the modification is applied. In at least one embodiment, a reboot is prioritized over other interrupts. For example, a custom resource applying three modifications with interrupts, two of which involve reboots, may coalesce the interrupts into one reboot within a package dependency graph. In other words, if an interrupt is a reboot, other interrupts are coalesced into a single reboot. If an interrupt is a service interrupt, the service interrupt is combined to restart services across all package interrupts. In at least one embodiment, a restart all services interrupt replaces other interrupts that only restart some services. Coalescing the interrupts improves the efficiency in implementing the interrupts by avoiding multiple restarts.

The package 108 operates as a containerized unit providing executable components and configuration data to apply a modification to a node. In at least one embodiment, the custom resource 102 includes one or more packages. While FIG. 1 illustrates the custom resource 102 with three packages, the custom resource 102 can include only one package or any number of packages. Each package corresponds with a modification to apply and the configuration data for application of the modification. This allows for the package 108 to be used and reused as a modular component with other packages in various custom resources to achieve various configurations for a computing cluster. As illustrated in FIG. 1, the package 108 includes an overlay 110 that includes environment variables 112, configuration maps 114, and an interrupt 116. In at least one embodiment, the package 108 provides dependency information. For example, the package 108 identifies modifications that are to be applied before the modification provided through the package 108 is to be applied.

The overlay 110 provides a container image that serves as the execution environment for the modification in the package 108. For example, the overlay 110 contains the runtime framework and agent code responsible for applying the modification on a node.

The environment variables 112 enable runtime configuration and parameterization of the deployment of the modification. The environment variables 112 allow for customization of the modification based on the situation in which the modification is deployed. For example, environment variables 112 provide security credentials, service ports, database connection strings, and other environment data associated with the computing cluster where the modification is deployed. The environment variables 112 provide a mechanism for passing dynamic configuration data to the package 108 without altering the underlying container image. In at least one embodiment, environment variables 112 includes references to secret or private information, such as passwords and API keys. The references allow the secret or private information to be passed through a cluster manager rather than fetched and stored in the package 108.

The configuration maps 114 provide additional configuration capabilities for the package 108 by supplying configuration data that can be mounted onto the package 108 during execution. The configuration maps 114 support various configuration scenarios that require structured data files, scripts, or other artifacts to be available. For example, the configuration maps 114 include environment specific application settings, URLs, and feature flags, which allow the package 108 to be configured for an environment without rebuilding the package 108.

The interrupt 116 provides additional interrupt information for the package 108. In at least one embodiment, the interrupt 116 provides environment specific interrupt types and environment specific interrupt budgets for a modification. For example, the interrupt 116 provides information indicating a first environment supports modification of nodes with a no operation interrupt while modification of nodes in a second environment involves node reboots. In at least one embodiment, the interrupt 116 works in conjunction with the interrupt configuration 106 to coordinate interrupt management and scheduling in a computing cluster.

In at least one embodiment, a computing cluster includes nodes that are read only. Changes made to the nodes are lost when the nodes are rebooted. For this computing cluster, custom resources are applied each time the nodes are rebooted. For example, an operator tracks and detects reboots of nodes in the computing cluster. On reboot of a node, the operator applies all the custom resources intended for the node before the node joins the computing cluster and becomes available.

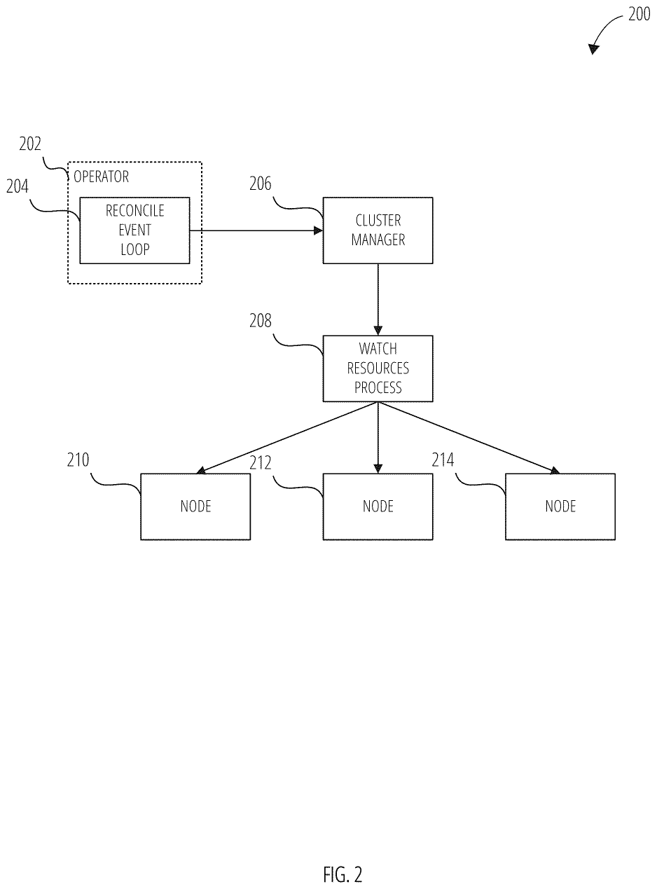

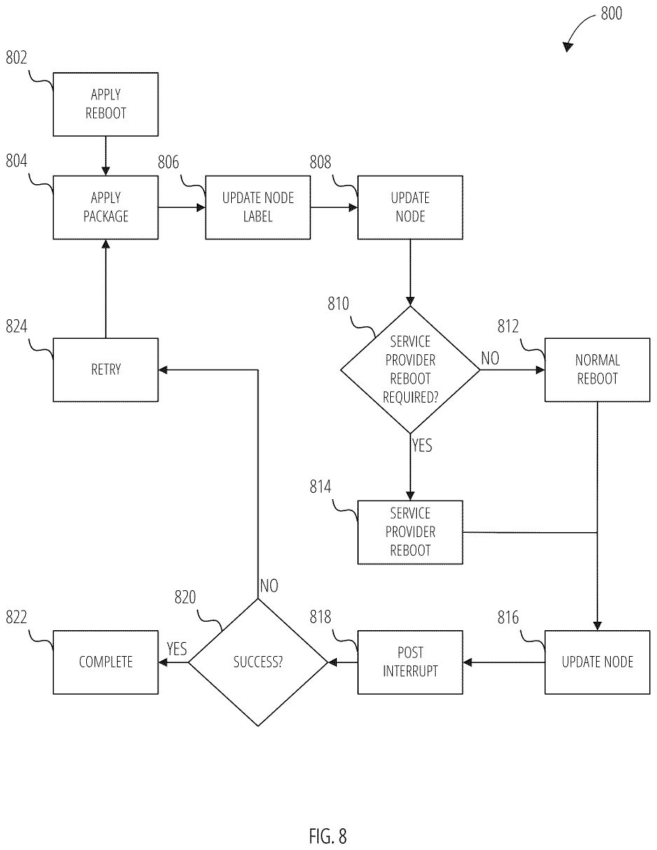

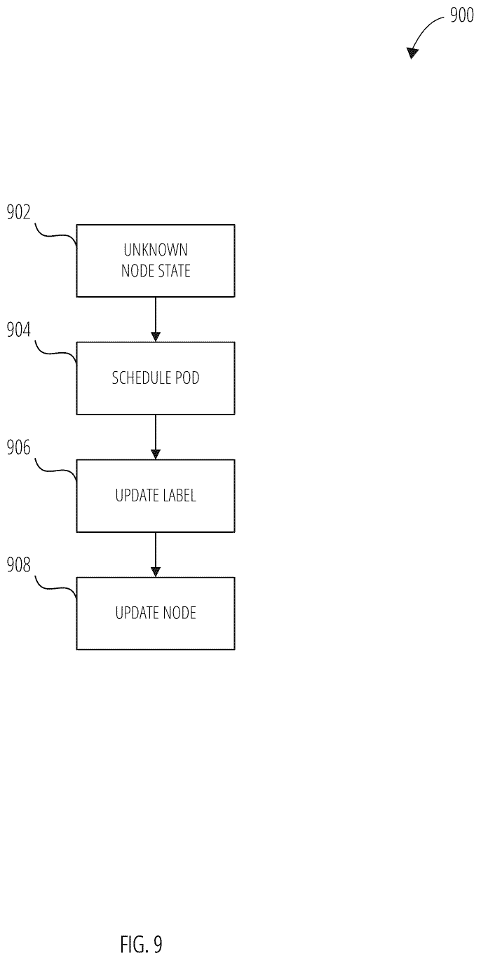

FIG. 2 is a block diagram illustrating an example system 200, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in at least one embodiment, the system and methods described herein may be implemented using one or more computing devices or components thereof (e.g., as described in FIG. 8) and/or one or more data centers or components thereof (e.g., as described in FIG. 9).

In FIG. 2, the example system 200 illustrates an operator 202 coordinating with a cluster manager 206 to monitor nodes 210, 212, 214 of a computing cluster and to apply modifications to the nodes 210, 212, 214.

The operator 202 runs a reconcile event loop 204 in which the operator 202, in communication with the cluster manager 206, continuously monitors state changes in the computing cluster, which are surfaced to the operator 202 as events by the cluster manager 206. The operator 202 responds to the state changes in the computing cluster to identify, for example, when the nodes 210, 212, 214 become available and coordinates with the cluster manager 206 to apply modifications to the nodes 210, 212, 214. For example, when the node 210 completes a workload, the completion of the workload is surfaced to the operator 202 by the cluster manager 206. The operator 202, running the reconcile event loop 204, responds to the completion of the workload and coordinates with the cluster manager 206 to prevent new workloads from being scheduled for the node 210. During this time, when the node 210 has completed its workload and is not receiving new workloads, the node 210 is available for modification. The operator 202 applies a modification to the node 210 while the node 210 is available. After the modification is applied, the operator 202 coordinates with the cluster manager 206 to allow new workloads to be scheduled for the node 210.

The reconcile event loop 204 is a continuous loop for processing events and state changes in the computing cluster. The reconcile event loop 204 is called repeatedly based on events within the computing cluster or at periodic intervals. In at least one embodiment, changes to a custom resource, including creation, updating, and deletion of custom resources, are surfaced as events. Events surfaced by the cluster manager 206 trigger the reconcile event loop 204. In response to an event, the reconcile event loop 204 queries the cluster manager 206 for information, such as a current state of the computing cluster or labels of the nodes 210, 212, 214 in the computing cluster. Based on the information, the operator 202 determines if the nodes 210, 212, 214 are available for a modification. For example, the operator 202 processes the events surfaced by the cluster manager 206 with a custom resource to filter events associated with a modification to be performed in accordance with the custom resource. Based on the events, the operator 202 queries the cluster manager 206 for labels of the nodes 210, 212, 214 and compares the labels with those in the custom resource to determine if the nodes 210, 212, 214 are in a state (e.g., interruptible, available) where a modification can be applied. In at least one embodiment, the reconcile event loop 204 processes different types of events including custom resource events, node events, and pod events, filtering these events based on their relevance to the functions the operator 202 are to perform.

The cluster manager 206 operates as an interface mechanism facilitating communication and coordination between the operator 202 and the computing cluster, including the nodes 210, 212, 214. In at least one embodiment, the cluster manager 206 provides an application programming interface (API) that allows the operator 202 to query the computing cluster and submit commands to the computing cluster.

In coordination with the operator 202, the cluster manager 206 monitors the state of the computing cluster, including the nodes 210, 212, 214. Changes to the state of the computing cluster, such as when one of the nodes 210, 212, 214 completes a workload, is scheduled a new workload, or is processing a workload, are detected and surfaced to the operator 202 by running a watch resources process 208. In at least one embodiment, the cluster manager 206 monitors for new nodes being added to the computing cluster and nodes being removed from the computing cluster. These events are detected and surfaced to the operator 202. In response to the events, the cluster manager 206 coordinates with the operator 202 to apply modifications to the nodes 210, 212, 214. For example, labels to prevent the cluster manager 206 from assigning new workloads are applied by the operator 202 in coordination with the cluster manager 206. When the cluster manager 206 assigns new workloads, the cluster manager 206 identifies nodes that are available to process new workloads (e.g., do not have the labels preventing new workloads). This allows new workloads to be scheduled while nodes are being modified. When modification of the nodes is completed and the labels preventing new workloads are removed, the cluster manager 206 identifies the nodes as available to process new workloads.

The cluster manager 206 runs the watch resources process 208 to monitor the nodes 210, 212, 214. The watch resources process 208 registers with the cluster manager 206 to facilitate event notifications when resources are created, modified, or deleted. The watch resources process 208 enables real-time monitoring of the computing cluster, including the nodes 210, 212, 214, so actions, such as application of modifications, are performed in response to real-time events. This allows the operator 202 to identify nodes to apply a modification based on their current state.

The nodes 210, 212, 214 are computing resources in the computing cluster that process workloads assigned by the cluster manager 206. For example, any node in the computing cluster, including the nodes 210, 212, 214, can function as an independent computing entity to execute workloads, host applications, or otherwise participate in operations of the computing cluster. In at least one embodiment, the nodes 210, 212, 214 are physical machines or virtual machines of the computing cluster and managed by the cluster manager 206.

The nodes 210, 212, 214 maintain connectivity with the cluster manager 206 through the watch resources process 208. For example, as the nodes 210, 212, 214 begin workloads, process workloads, and complete workloads, the states of the nodes 210, 212, 214 are reported to the cluster manager 206 through the watch resources process 208. Changes in the states of the nodes 210, 212, 214 are surfaced to the operator 202 to facilitate identification of available nodes for application of a modification. For example, labels associated with the nodes 210, 212, 214 are updated based on the current state of the nodes 210, 212, 214. These labels are used to determine the current state of the nodes 210, 212, 214 and to identify which of the nodes 210, 212, 214 are available to apply a modification.

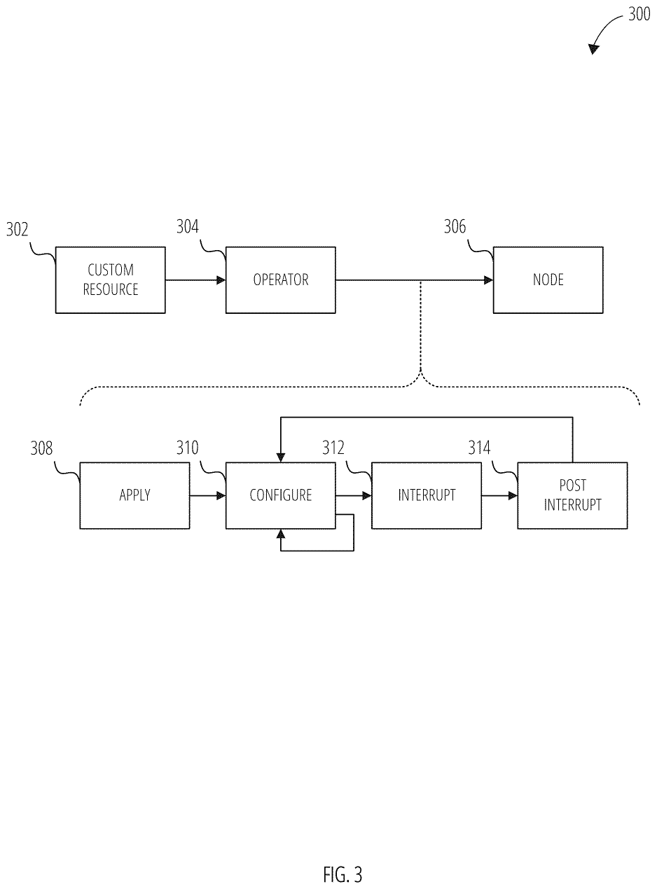

FIG. 3 is a block diagram illustrating an example system 300, in accordance with at least one embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in at least one embodiment, the system and methods described herein may be implemented using one or more computing devices or components thereof (e.g., as described in FIG. 8) and/or one or more data centers or components thereof (e.g., as described in FIG. 9).

In FIG. 3, the example system 300 illustrates an operator 304 applying a modification to a node 306 based on a custom resource 302. For example, the operator 304 identifies the node 306 as a node to apply a modification indicated in the custom resource 302 based on targeting conditions indicated in the custom resource 302. The targeting conditions indicated in the custom resource 302 provide matching functions that facilitate identification of the node 306 based on the labels of the node 306. In at least one embodiment, the custom resource 302 provides interrupt configurations and package definitions for application of the modification.

As illustrated in FIG. 3, the operator 304 applies the modification to the node 306 based on an example method including an apply operation 308, a configuration operation 310, an interrupt operation 312, and a post interrupt operation 314. At the apply operation 308, the operator 304 determines whether the node 306 satisfies the targeting conditions for application of the modification, including whether the node 306 is processing a workload. For example, the operator 304 determines the node 306 is processing a workload based on labels associated with the node 306. Based on the node 306 processing the workload, the operator 304 waits until the node 306 completes the workload to begin application of the modification. The operator 304 determines the node 306 has completed the workload, for example, based on the labels associated with the node 306. In at least one embodiment, the operator 304 performs check stages for the apply operation 308, the configuration operation 310, and the post interrupt operation 314. For example, the operator 304, after the apply operation 308, performs a check-apply operation to determine that the processes performed for the apply operation 308 are correctly applied before proceeding to the next operation.

At the configuration operation 310, the operator 304 processes the configuration aspects of applying a modification to the node 306. The configuration aspects include, for example, processing of environment variables and configuration maps defined in the custom resource 302. The operator 304 mounts this configuration data into a package container during execution to apply the modification to the node 306. For example, the operator 304 processes the environment variables to configure and parameterize the package execution of the modification to be applied to the node 306 at runtime. The operator 304 mounts configuration data from the configuration maps to facilitate appropriate configuration changes to the package container before applying the modification to the node 306.

In at least one embodiment, the application of a modification to the node 306 includes managing configuration operations over multiple stages. For example, the modification to the node 306 may include a set of modifications to be applied in a sequence. The modification to the node 306 may include dependencies on other modifications to be applied beforehand. The operator 304 monitors the node 306 to manage ongoing modification processes. In at least one embodiment, the ongoing modification processes are documented as labels associated with the node 306 to facilitate the correct sequence of modification application.

In at least one embodiment, application of a modification to the node 306 includes an interrupt that is indicated by the custom resource 302. At the interrupt operation 312, the operator 304, in coordination with a cluster manager, disrupts operations of the node 306 based on an interruption type indicated by the custom resource 302. For example, the operator 304 may cause the node 306 to perform a node reboot or a service restart following performance of a configuration operation. The interruption caused by the operator 304 is performed in coordination with the cluster manager to maintain coordination with the overall computing cluster.

In at least one embodiment, the interrupt operation 312 is performed based on an interrupt budget provided by the custom resource 302. The operator 304, in coordination with the cluster manager, monitors the number of nodes in the computing cluster that are interrupted, and prevents the number of nodes in the computing cluster that are interrupted from exceeding the interrupt budget.

At the post interrupt operation 314, the operator 304 performs post interrupt instructions provided by the custom resource 302. For example, the operator 304 performs cleanup and verification operations after the node 306 is interrupted and returns to an operational state. In at least one embodiment, application of a modification to the node 306 is performed following an interrupt of the node 306. As illustrated in FIG. 3, configuration operation 310 may be performed following the post interrupt operation 314 to apply a modification to the node 306 following the interrupt operation 312.

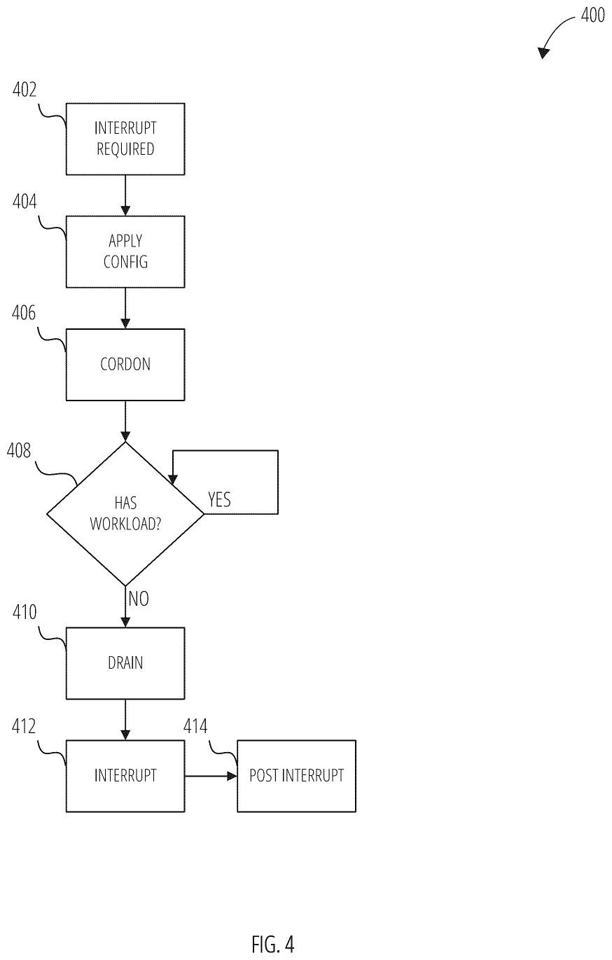

FIG. 4 is a flow diagram illustrating an example method 400 for applying a modification involving an interrupt, in accordance with at least one embodiment. Each operation of the example method 400, described herein, comprises a computing process that may be performed using any combination of hardware, firmware, and/or software. For instance, various functions may be carried out using one or more processors executing instructions stored in one or more memories. The example method 400 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 400 is described, by way of example, with respect to the systems of FIGS. 2-3. However, this method may additionally or alternatively be executed by any one system, or any combination of systems, including, but not limited to, those described herein.

At operation 402, the operator determines if an interrupt is required for a node modification operation. The determination is based on a custom resource that specifies interrupt configurations for a modification to be applied. For example, the operator compares labels of a node with an interrupt configuration of a modification to determine if the modification is to be applied to the node and if the application of the modification to the node involves an interrupt.

At operation 404, the operator applies configuration settings to a target node. For example, the operator uses data from environment variables, configuration maps, and interrupt data specified in the custom resource to apply a modification appropriate for the target node. The environment variables and configuration maps are, for example, mounted to a package container to provide the operational parameters for applying the modification to the target node.

At operation 406, the operator cordons the target node. For example, the operator, in coordination with a cluster manager, applies a label to the target node to mark the target node as unavailable for scheduling new workloads. The label acts as a taint to indicate to the cluster manager to avoid scheduling new workloads to the target node. By cordoning the target node, the target node is effectively removed from the computing cluster as modifications are applied to the target node.

At operation 408, the operator determines whether the target node has a workload that the target node is processing. For example, the operator queries the cluster manager to determine whether a workload is running on the target node. In at least one embodiment, the operator determines whether the target node is processing a workload based on labels associated with the target node. While the target node has a workload that the target node is process, the operator monitors the target node to determine when the target node completes the workload.

If the target node completes its workload or no longer has a workload it is processing, then at operation 410, the operator, in coordination with the cluster manager, drains the target node. Draining the target node includes evicting existing workloads from the target node and data processed in the target node. In at least one embodiment, draining the target node includes sending termination signals to processes running in the target node to cause the processes to terminate and complete shutdown operations. Draining the node avoids loss of data before application of the modification to the target node.

At operation 412, the operator, in coordination with the cluster manager, interrupts the target node. The interrupt performed for the target node is based on, for example, the interrupt configuration and interrupt data of the custom resource used for application of the modification to the target node. The interrupt may be, for example, a node reboot, a service restart, or a no-op interrupt. In at least one embodiment, the interrupt includes a restart for all services. Modifications to the target node may be applied at this point.

At operation 414, the operator performs post-interrupt instructions. The post-interrupt instructions are provided, for example, by the custom resource. For example, the custom resource may include post-interrupt instructions such as verification scripts, service restart procedures, and system validation checks.

In at least one embodiment, a user alters or modifies a custom resource, such as the environment variables or configuration maps of a package in the custom resource. The alteration of the custom resource triggers the example method 400. For example, in response to an alteration of the custom resource, an operator identifies nodes that are to be modified based on the altered custom resource. For the nodes that are to be modified, the application of the modification involving an interrupt, as illustrated in example method 400, is performed.

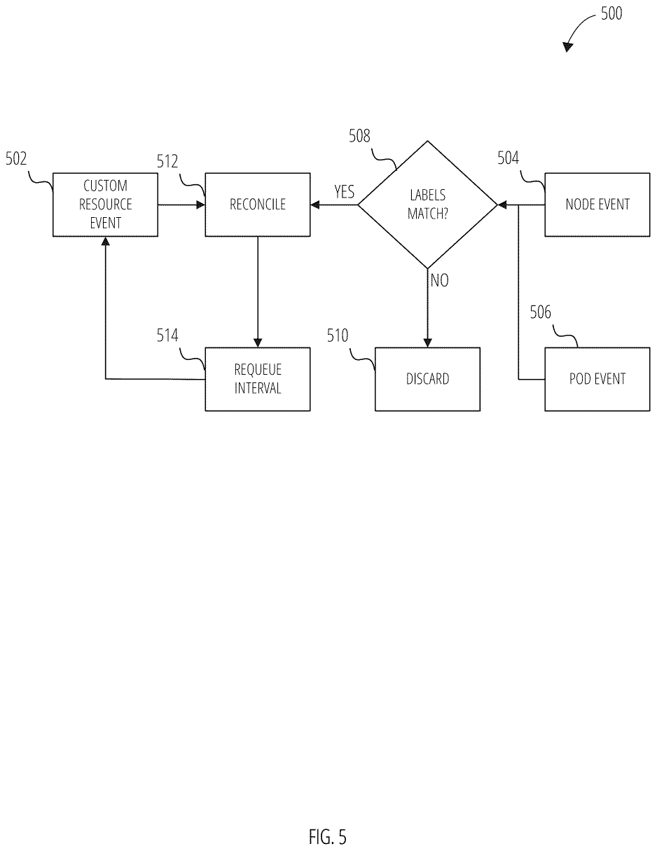

FIG. 5 is a flow diagram illustrating an example method 500 for monitoring events on a computing cluster, in accordance with at least one embodiment. Each operation of the example method 500, described herein, comprises a computing process that may be performed using any combination of hardware, firmware, and/or software. For instance, various functions may be carried out using one or more processors executing instructions stored in one or more memories. The example method 500 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 500 is described, by way of example, with respect to the systems of FIGS. 2-3. However, this method may additionally or alternatively be executed by any one system, or any combination of systems, including, but not limited to, those described herein.

At operation 502, the operator reads a custom resource event to identify an event to monitor. For example, the custom resource event is provided by a custom resource that provides an event to monitor to trigger application of a modification. The operator reads the custom resource event and compares the event provided by the custom resource event with events surfaced by a cluster manager to determine whether an event to trigger application of a modification has occurred. The comparison is, for example, based on labels associated with the nodes of the computing cluster.

At operation 504, the operator reads a node event surfaced by the cluster manager. The node event, for example, includes changes to nodes of the computing cluster. The changes include, for example, an addition of a node, a removal of a node, a node becoming unavailable (e.g., network error, hardware error, repeated crashes), a node completing a workload, a node being scheduled a workload, a node processing a workload, and other changes to the states of the nodes in the computing cluster.

At operation 506, the operator reads a pod event surfaced by the cluster manager. In at least one embodiment, a pod is a deployable unit that runs on a node. In at least one embodiment, one or more pods run on a node, sharing resources of the node. The operator reads the pod event to determine a state of the node on which the pod is running. For example, the pod event may indicate that a pod is created for a node, a pod is scheduled for a node, a pod is waiting for resources on a node, a pod is running on a node, a pod has completed on a node, a pod has been removed from a node, and other changes to the state of the pod on the node.

At operation 508, the operator determines if the node event read at operation 504 and the pod event read at operation 506 are associated with labels that satisfies a matching function associated with the custom resource event. The operator compares the label associated and the node event and the label associated with the matching function of the custom resource event to determine whether an event has occurred to trigger the modification provided in the custom resource.

If the label associated with the node event and the label associated with the pod event do not satisfy the matching function, then at operation 510, data associated with the node event and the pod event are discarded. If the label associated with the node event or the label associated with the pod event satisfy the matching function, then at operation 512, the operator performs a reconcile process to determine a response to the event. In at least one embodiment, the operator initiates application of a modification to a node, as provided in the custom resource, in response to the label associated with the node event or the label associated with the pod event satisfying the matching function provided in the custom resource.

At operation 514, the operator performs a requeue interval to continue monitoring for custom resource event. In at least one embodiment, the operator periodically queries the cluster manager for the custom resource event to determine if an event matching the custom resource event has occurred. In at least one embodiment, the operator compares events surfaced to the operator by the cluster manager with the custom resource event to determine if the events match the custom resource event.

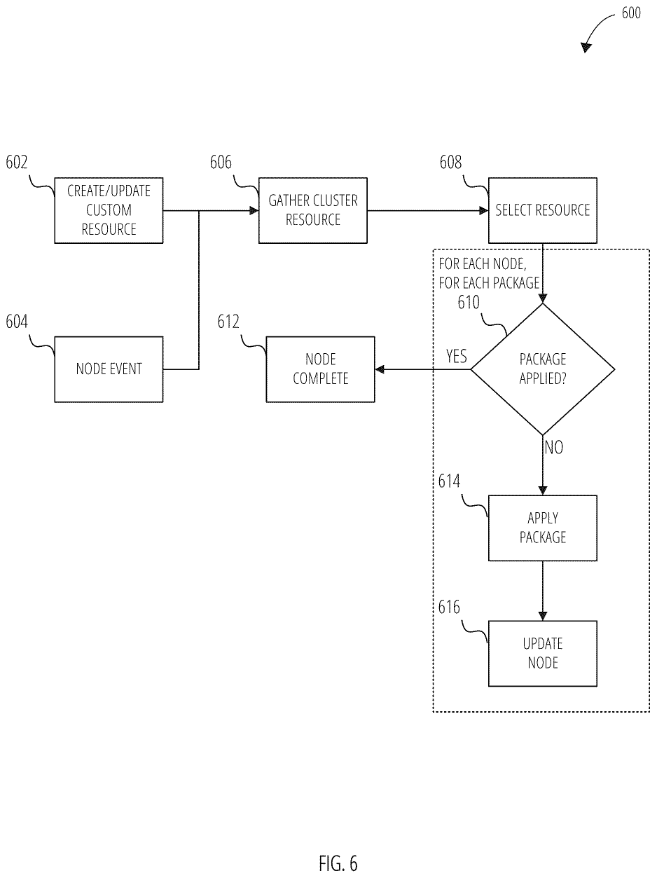

FIG. 6 is a flow diagram illustrating an example method 600 for applying packages of a custom resource to a computing cluster, in accordance with at least one embodiment. Each operation of the example method 600, described herein, comprises a computing process that may be performed using any combination of hardware, firmware, and/or software. For instance, various functions may be carried out using one or more processors executing instructions stored in one or more memories. The example method 600 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 600 is described, by way of example, with respect to the systems of FIGS. 2-3. However, this method may additionally or alternatively be executed by any one system, or any combination of systems, including, but not limited to, those described herein.

As illustrated in FIG. 6, a custom resource is used to apply modifications to nodes of a computing cluster to implement changes to the computing cluster. For example, system-wide changes to the computing cluster allow the computing cluster to be repurposed for different applications. Through a systematic approach, the operator applies modifications to the nodes of the computing cluster to effectively change the computing cluster from one application to a different application.

At operation 602, a custom resource is created or updated. For example, a custom resource is created with packages for modifications to apply to the nodes of the computing cluster to implement the packages for the computing cluster. The custom resource provides, for example, labels to identify nodes of the computing cluster to implement the packages and modifications to apply to implement the packages. The custom resource provides, for example, configuration data for application of the modifications.

At operation 604, the operator receives a node event. The node event, for example, indicates a change in a state of a node of the computing cluster. The operator determines an operation to perform in response to the node event based on the custom resource. For example, in response to a node event indicating that a node has completed a workload, the operator initiates an application of a modification to the node.

At operation 606, the operator gathers cluster resources. For example, the operator queries the cluster manager of the computing cluster to collect information regarding the current state of the computing cluster, including node statuses, node metadata, pod assignments, label information, workload distribution data, and existing resource configurations. Using the information collected from the cluster manager, the operator appropriately configures the packages of the custom resource to apply to the nodes of the computing cluster.

At operation 608, the operator selects a resource. The operator identifies target nodes to apply a modification and selects the resource for the modification. The resource includes, for example, a package of the custom resource with the modification to apply to the target nodes. In at least one embodiment, the resource is configured using the environment variables and configuration maps provided in the custom resource.

At operation 610, for each node identified by the operator, and for each package, the operator determines if the modifications to implement the package have been applied. This determination is based on labels of each node that indicate a history of modifications applied to each node. Based on the labels, the operator identifies modifications that have not been applied to each node.

If all the modifications to implement the package have been applied to each node, for each package, then at operation 612, each node is complete. If not all the modifications to implement the packages have been applied to each node, then at operation 614, the operator applies the modifications to each node to implement the packages. The modifications applied include those that have not been indicated as having been applied based on the labels associated with each node.

At operation 616, the operator updates each node to indicate that the modifications to implement the packages have been applied. These updates include labels, or annotations, associated with each node to update the history of modifications applied to each node.

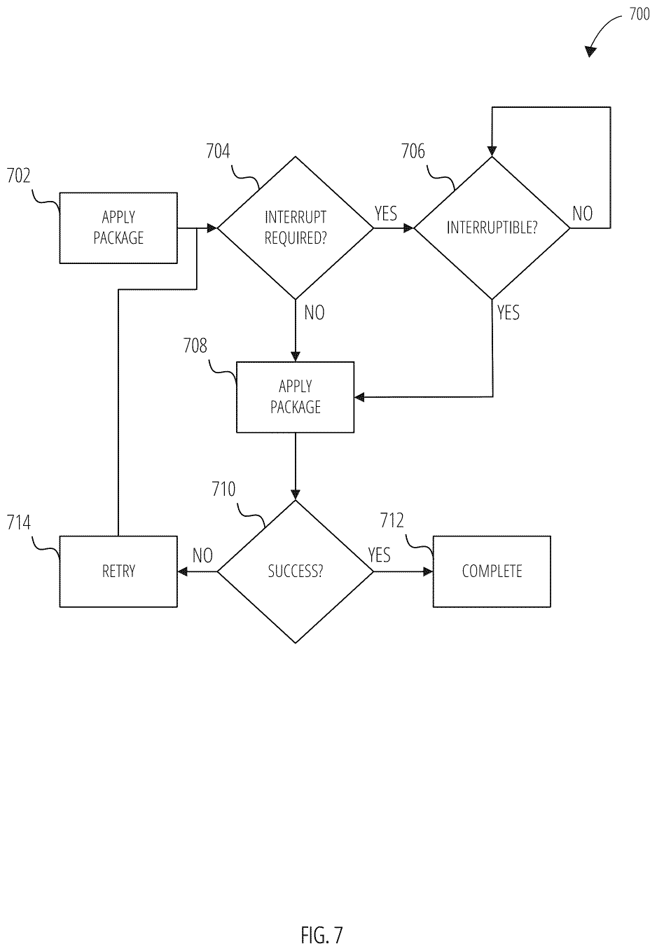

FIG. 7 is a flow diagram illustrating an example method 700 for applying a package to a computing cluster, in accordance with at least one embodiment. Each operation of the example method 700, described herein, comprises a computing process that may be performed using any combination of hardware, firmware, and/or software. For instance, various functions may be carried out using one or more processors executing instructions stored in one or more memories. The example method 700 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 700 is described, by way of example, with respect to the systems of FIGS. 2-3. However, this method may additionally or alternatively be executed by any one system, or any combination of systems, including, but not limited to, those described herein.

At operation 702, the operator initiates an apply package process. The process includes identifying nodes of the computing cluster to modify to implement the package. The nodes are identified, for example, based on labels associated with the nodes and matching functions provided by a custom resource. The operator identifies a node and determines a modification to apply to the node to implement the package based on the labels associated with the node.

At operation 704, the operator determines if an interrupt is required to apply the modification to the node. The determination is based on, for example, interrupt configuration data of the custom resource. The interrupt configuration data indicates whether the modification to apply to the node requires an interrupt before the application of the modification.

If an interrupt is required to apply the modification to the node, then at operation 706, the operator determines if the node is interruptible. If the node is processing a workload or otherwise unavailable for application of the modification, the operator determines whether the workload is an interruptible workload. The operator makes this determination based on labels associated with the node that indicate, for example, whether the node is processing an interruptible workload or an uninterruptible workload. In at least one embodiment, the labels associated with the node indicate a level of priority associated with the workload the node is processing. The operator determines whether the workload is interruptible or uninterruptible based on the level of priority.

In at least one embodiment, the operator determines whether a node is interruptible or uninterruptible based on an interrupt budget. The interrupt budget provides a maximum number of nodes or a maximum percentage of nodes that can be removed from the computing cluster at a given time for modification. The interrupt budget functions as a control mechanism to prevent the computing cluster from disrupting an excessive number of nodes, thereby maintaining sufficient operational capacity within the computing cluster while modifications are applied. To determine whether the node is interruptible or uninterruptible, the operator monitors a current number of nodes that have been removed from the computing cluster for modification and compares the current number with the interrupt budget. If the current number is within the interrupt budget, the node is interruptible provided it is not processing an uninterruptible workload. If the current number is at or exceeds the interrupt budget, the node is uninterruptible until another node has completed modification. In at least one embodiment, interrupt budgets correspond with different node types. For example, a first interrupt budget corresponds with a first type of node, such as control plane nodes, and a second interrupt budget corresponds with a second type of node, such as worker nodes. In at least one embodiment, budgets for application of modifications are used in situations besides interrupting nodes to, for example, implement rolling updates. The budgets facilitate a controlled rate of modifications to address situations that call for a gradual roll out of updates.

If, the workload is uninterruptible, then the operator waits for the node to complete the workload or for the node to process an interruptible workload. For example, the operator tracks nodes in the computing cluster and maintains an internal priority of nodes that the operator is operating on to determine when the node has completed a workload.

At operation 708, the operator applies the modification to implement the package. The operator applies the modification in response to, for example, a determination that no interrupt is required to apply the modification. In at least one embodiment, the operator applies the modification in response to a determination the node is processing an interruptible workload. If the node is processing an interruptible workload, the operator causes the workload to be interrupted before applying the modification. In at least one embodiment, the operator waits for an uninterruptible workload to complete before applying the modification.

At operation 710, the operator determines if the modification was applied successfully. For example, the operator performs verification checks to determine if the node was successfully modified. If the operator determines that the node was successfully modified, then at operation 712, the application of the modification is complete. In at least one embodiment, a determination that a modification was successfully applied is based on a lack of errors detected. If the operator determines that the node was not successfully modified, then at operation 714, the operator retries the application of the modification. As illustrated in FIG. 7, the retry of the application of the modification includes reevaluating whether application of the modification to the node requires an interrupt and whether a workload on the node is interruptible.

FIG. 8 is a flow diagram illustrating an example method 800 for applying a package to a computing cluster, in accordance with at least one embodiment. Each operation of the example method 800, described herein, comprises a computing process that may be performed using any combination of hardware, firmware, and/or software. For instance, various functions may be carried out using one or more processors executing instructions stored in one or more memories. The example method 800 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 800 is described, by way of example, with respect to the systems of FIGS. 2-3. However, this method may additionally or alternatively be executed by any one system, or any combination of systems, including, but not limited to, those described herein.

At operation 802, the operator initiates a process to reboot a node of a computing cluster. The reboot, for example, facilitates the node rejoining the computing cluster and being available for new workloads following application of a modification. In at least one embodiment, the operator prepares the node for modification and reboot by performing a cordon operation and a drain operation to remove the node from the computing cluster and safely remove data from the node.

At operation 804, the operator applies the modification to implement the package. The modification, for example, is provided by a custom resource to implement the package on the computing cluster. The modification for the node is identified based on matching functions provided by the custom resource to identify the appropriate modification to apply to the node to implement the package. The matching function matches the appropriate modification to the node based on the labels associated with the node.

At operation 806, the operator updates the labels of the node. The labels, or annotations, of the node are updated to reflect the application of the modification to the node. For example, labels, or annotations, providing a history of modifications applied to the node are updated to reflect the latest modification to the node.

At operation 808, the operator updates the node. The node is updated with appropriate metadata and parameters, so the node is rebooted and rejoins the computing cluster following the reboot. In at least one embodiment, the node is updated based on a type of reboot to be performed, such as node reboot or service reboot.

At operation 810, the operator determines whether a service provider reboot is required. For example, the computing cluster may be hosted by a cloud service provider, and node reboots in the computing cluster are handled by the cloud service provider. The mechanism for rebooting the node is based on environmental variables and configuration maps provided by the custom resource to appropriately configure the custom resource for the computing cluster.

If a service reboot is not required, then at operation 812, a normal reboot is performed. For example, the node is rebooted using an operating system command to restart the physical or virtual machine the node represents. If a service reboot is required, then at operation 814, a service provider reboot is performed. For example, the node is rebooted using an automated reboot process provided by the service provider. The service provider may provide a console command or other option for rebooting the node.

At operation 816, the operator updates the node. For example, the node is updated to remove labels that cordon the node from the computing cluster, allowing the cluster manager to schedule new workloads for the node. In at least one embodiment, the operator updates node metadata and parameters to facilitate the node rejoining the computing cluster.

At operation 818, the operator performs post interrupt instructions. For example, the operator performs cleanup operations and additional configuration steps to return the node to an operational state. In at least one embodiment, the post interrupt instructions include validation checks to determine if the modification was successfully applied and the node was successfully rebooted and ready to process new workloads.

At operation 820, the operator determines whether the node was successfully modified and successfully rebooted. This determination is based on, for example, validation checks, which may be provided as post interrupt instructions by the custom resource.

If the operator determines the node was successfully modified and successfully rebooted, then at operation 822, the modification is complete. The node rejoins the computing cluster and processes new workloads scheduled by the cluster manager. If the operator determines the node was not successfully modified or not successfully rebooted, then at operation 824, the operator retries the modification and the reboot process.

FIG. 9 is a flow diagram illustrating an example method 900 for recovering a state of a node, in accordance with at least one embodiment. Each operation of the example method 900, described herein, comprises a computing process that may be performed using any combination of hardware, firmware, and/or software. For instance, various functions may be carried out using one or more processors executing instructions stored in one or more memories. The example method 900 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 900 is described, by way of example, with respect to the systems of FIGS. 2-3. However, this method may additionally or alternatively be executed by any one system, or any combination of systems, including, but not limited to, those described herein.

In at least one embodiment, application of a modification to a node may fail and leave a node in an unknown state. The operator determines the state of the node based on labels associated with the node. For example, labels providing a history of modifications applied to the node indicate a current state of the node with respect to what modifications have been applied to the node. In at least one embodiment, an inspection of the node's file system facilitates a determination of the state of the node.

At operation 902, the operator identifies a node with an unknown state. For example, the operator detects that a node exists in a computing cluster in an unknown state based on metadata associated with the computing cluster. The computing cluster metadata may lack state information with respect to the node while the operator detects the presence of the node in the computing cluster. In at least one embodiment, the operator identifies the node with the unknown state following a failed application of a modification to the node or the node being added to the computing cluster without appropriate state initialization.

At operation 904, the operator schedules a pod operation to inspect the node. For example, the operator schedules a pod operation to inspect a file system of the node to determine the state of the node. Inspection of the file system allows the operator to determine what modifications have been applied and if the modifications were applied successfully.

At operation 906, the operator updates labels of the node. The labels, or annotations, of the node are updated to reflect the current state of the node as determined based on the pod operation. For example, if a modification was not successfully applied, the labels, or annotations, of the node are updated to indicate that the node does not have the modification applied. If the node is a new node added to the computing cluster, the labels, or annotations, of the node are updated to indicate that the node is a new node.

At operation 908, the operator updates the node. The node is updated to have the appropriate metadata and parameters to operate within the computing cluster. In at least one embodiment, the node is updated through labels to reflect modifications that are to be applied to bring the node to an operational state as specified by a custom resource. For example, if a modification to the node was not successfully applied, the node is updated to indicate that a retry of the modification will be performed.

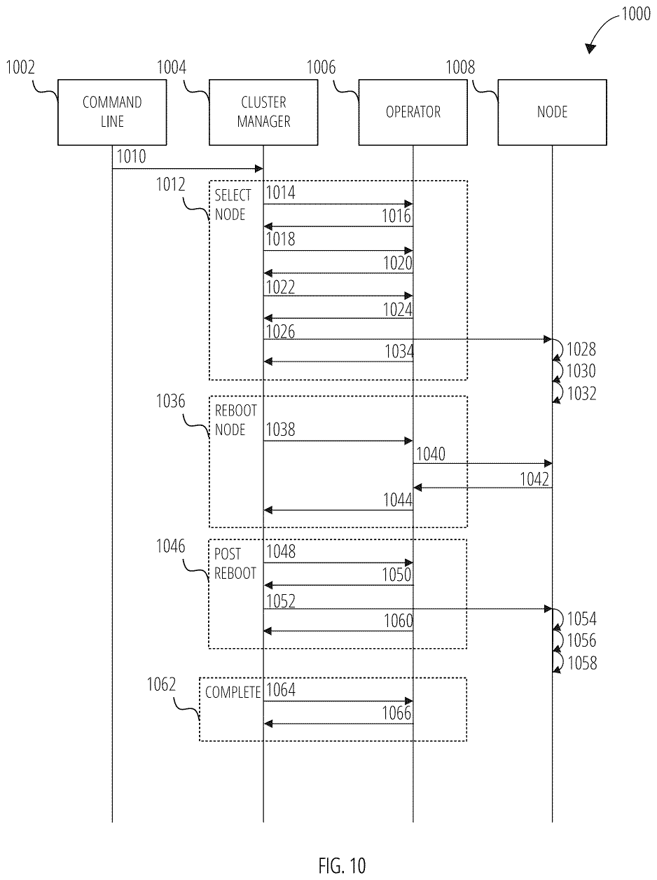

FIG. 10 is a timing diagram illustrating an example system 1000 performing a modification of a node, in accordance with at least one embodiment. Each operation performed by the example system 1000, described herein, comprises a computing process that may be performed using any combination of hardware, firmware, and/or software. For instance, various functions may be carried out using one or more processors executing instructions stored in one or more memories. The operations performed by the example system 1000 may also be embodied as computer-usable instructions stored on computer storage media. The operations may be provided by a standalone application, a service or hosted service (standalone or in combination with another hosted service), as a microservice via an application programming interface (API) or a plug-in to another product, to name a few. In addition, the operations performed by the example system 1000 may be performed by the systems of FIGS. 2-3. Additionally, or alternatively, the operations performed by the example system 1000 may be executed by any one system, or any combination of systems, including, but not limited to, those described herein.

As illustrated in FIG. 10, the example system 1000 includes a command line 1002, a cluster manager 1004, an operator 1006, and a node 1008. The command line 1002 serves as an interface for interacting with and managing a computing cluster. The command line 1002 allows a user to provide instructions to the cluster manager 1004. The cluster manager 1004 implements the instructions for the computing cluster. The operator 1006, in coordination with the cluster manager 1004, monitors and manages the computing cluster to implement instructions provided through the command line 1002 and, for example, custom resources provided to the computing cluster. These instructions, for example, may cause a modification to be applied to the node 1008 of the computing cluster.

At operation 1010, the command line 1002 provides an instruction to the cluster manager 1004. The instruction, for example, provides the cluster manager 1004 with a custom resource to apply a modification to the node 1008.

At operation 1012, the cluster manager 1004 in coordination with the operator 1006 selects the node 1008 to apply the modification. As part of the selection of the node 1008, at operation 1012, the cluster manager 1004 surfaces an event to the operator 1006. The event, for example, indicates to the operator 1006 that a change to the state of the computing cluster has occurred. In response to the event, at operation 1016, the operator 1006 queries the cluster manager 1004 for a list of nodes in the computing cluster. At operation 1018, the cluster manager 1004 provides the list of nodes to the operator 1006 in response to the query. At operation 1020, the operator 1006 queries the cluster manager 1004 for a list of pods operating on the computing cluster. At operation 1022, the cluster manager 1004 provides the list of pods in response to the query. The operator 1006 uses the list of nodes and the list of pods, and the labels associated with the nodes and pods to identify the node 1008 as available for a modification based on the custom resource. At operation 1024, the operator creates a pod for the cluster manager 1004 to cordon the node 1008 and drain the node 1008. At operation 1026, the cluster manager 1004 in coordination with the operator 1006 provides the node 1008 with instructions to run. These instructions include, for example, operations for facilitating application of the modification on the node 1008. At operation 1028, the node 1008 executes the instructions. At operation 1030, labels are applied to the node 1008. These labels indicate, for example, that the node is unavailable for scheduling new workloads. At operation 1032, the node 1008 completes the instructions. At operation 1034, the operator 1006 provides a status to the cluster manager 1004 with respect to the custom resource. For example, the operator 1006 updates the cluster manager 1004 that the node 1008 is being updated based on the custom resource and to prevent new workloads from being scheduled to the node 1008 while the modification is applied to the node 1008.

At operation 1036, the node 1008 is rebooted as part of the application of the modification to the node 1008. As part of the rebooting of the node 1008, at operation 1038, the cluster manager 1004 provides an event to the operator 1006. The event, for example, indicates to the operator 1006 that a change to the state of the computing cluster, such as the node 1008 being available for a reboot, has occurred. At operation 1040, the operator 1006 provides instructions to the node 1008 to reboot. In at least one embodiment, the operator 1006 provides instructions to a service provider to reboot the node 1008. At operation 1042, the node 1008 provides the operator 1006 with an update indicating the reboot has been performed. At operation 1044, the operator 1006 provides a status to the cluster manager 1004 with respect to the custom resource. For example, the operator 1006 updates the cluster manager 1004 that the node 1008 has been modified and rebooted based on the custom resource.

At operation 1046, post reboot instructions are executed for the node 1008. The post reboot instructions, or post interrupt instructions, are provided, for example, as part of the custom resource. As part of the executing the post reboot instructions, at operation 1048, the cluster manager 1004 provides an event to the operator 1006. The event, for example, indicates to the operator 1006 that a change to the state of computing cluster, such as the node 1008 being rebooted and joined to the computing cluster, has occurred. At operation 1050, the operator 1006 creates a pod for the cluster manager 1004 to instruct the node 1008 to perform post reboot instructions. At 1052, the cluster manager 1004, in coordination with the operator 1006, provides instructions to the node 1008 to execute. The instructions include, for example, operations for validating the modification, clean up operations, and other configuration operations. At operation 1054, the node 1008 executes the instructions. At operation 1056, labels are applied to the node 1008. The labels indicate, for example, that the node 1008 has validated the modification and the modification has successfully been applied to the node 1008. At operation 1058, the node completes the instructions. At operation 1060, the operator 1006 provides a status to the cluster manager 1004 with respect to the custom resource. For example, the operator 1006 updates the cluster manager 1004 to indicate that the node 1008 is successfully modified based on the custom resource and is available for new workloads.

At operation 1062, completion instructions are executed. The completion instructions include, for example, queries to determine whether the node 1008 is up to date with respect to the custom resource. As part of the completion instructions, at operation 1064, the cluster manager provides an event to the operator 1006. The event, for example, is part of a polling operation to determine the current status of the node 1008. At operation 1066, the operator 1006 provides a status to the cluster manager 1004 with respect to the custom resource. For example, the operator determines the status of the node 1008 based on labels associated with the node 1008 and updates the cluster manager 1004 that the node 1008 is up to date with respect to the custom resource.

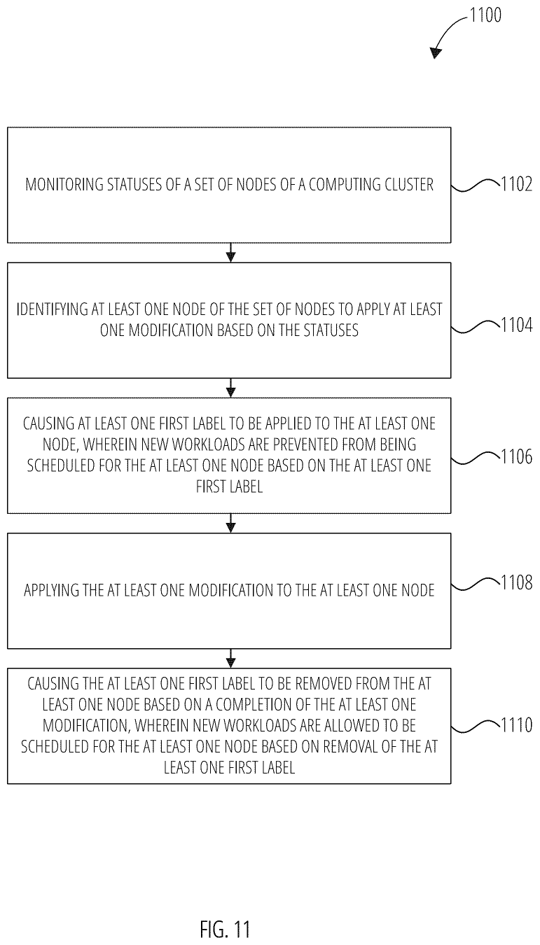

FIG. 11 is a flow diagram illustrating an example method 1100, in accordance with at least one embodiment. Each operation of the example method 1100, described herein, comprises a computing process that may be performed using any combination of hardware, firmware, and/or software. For instance, various functions may be carried out using one or more processors executing instructions stored in one or more memories. The example method 1100 may also be embodied as computer-usable instructions stored on computer storage media. The method may be provided by a standalone application, a service or hosted service (standalone or in combination with another hosted service), as a microservice via an application programming interface (API) or a plug-in to another product, to name a few. In addition, the example method 1100 is described, by way of example, with respect to the systems of FIGS. 2-3. However, this method may additionally or alternatively be executed by any one system, or any combination of systems, including, but not limited to, those described herein.

At operation 1102, an operator monitors the statuses of a set of nodes of a computing cluster. The operator monitors the statuses, for example, by receiving event information from a cluster manager of the computing cluster or, for example, by accessing labels of the set of nodes of the computing cluster. At operation 1104, the operator identifies at least one node of the set of nodes to apply at least one update based on the statuses. For example, the operator uses matching functions provided by a custom resource to identify nodes that are targets for the modification and determines whether the nodes are available for the modification based on labels associated with the nodes. At operation 1106, the operator causes at least one first label to be applied to the at least one node, wherein new workloads are prevented from being scheduled for the at least one node based on the at least one first label. For example, the first label is a taint that indicates to the cluster manager that new workloads are not to be scheduled for the node. At operation 1108, the operator applies the at least one modification to the at least one node. For example, the modification is an update to an operating system of the node. At operation 1110, the operator causes the at least one first label to be removed from the at least one node based on a completion of the at least one modification, wherein new workloads are allowed to be scheduled for the at least one node based on removal of the at least one first label. For example, removal of the taint indicates to the cluster manager that new workloads may be scheduled for the node.

### Example Computing Device

FIG. 12 is a block diagram of an example computing device 1200 suitable for use in implementing some embodiments of the present disclosure. Computing device 1200 may include an interconnect system 1202 that directly or indirectly couples the following devices: memory 1204, one or more central processing units (CPUs) 1206, one or more graphics processing units (GPUs) 1208, a communication interface 1210, input/output (I/O) ports 1212, input/output (I/O) components 1214, a power supply 1216, one or more presentation components 1218 (e.g., display(s)), and one or more logic units 1220. In at least one embodiment, the computing device 1200 may comprise one or more virtual machines (VMs), and/or any of the components thereof may comprise virtual components (e.g., virtual hardware components). For non-limiting examples, one or more of the GPU(s) 1208 may comprise one or more vGPUs, one or more of the CPU(s) 1206 may comprise one or more vCPUs, and/or one or more of the logic unit(s) 1220 may comprise one or more virtual logic units. As such, a computing device 1200 may include discrete components (e.g., a full GPU dedicated to the computing device 1200), virtual components (e.g., a portion of a GPU dedicated to the computing device 1200), or a combination thereof.

Although the various blocks of FIG. 12 are shown as connected via the interconnect system 1202 with lines, this is not intended to be limiting and is for clarity only. For example, in some embodiments, a presentation component 1218, such as a display device, may be considered an I/O component 1214 (e.g., if the display is a touch screen). As another example, the CPUs 1206 and/or GPUs 1208 may include memory (e.g., the memory 1204 may be representative of a storage device in addition to the memory of the GPU(s) 1208, the CPU(s) 1206, and/or other components). As such, the computing device of FIG. 12 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 12.

The interconnect system 1202 may represent one or more links or busses, such as an address bus, a data bus, a control bus, or a combination thereof. The interconnect system 1202 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU(s) 1206 may be directly connected to the memory 1204. Further, the CPU(s) 1206 may be directly connected to the GPU(s) 1208. Where there is direct, or point-to-point connection between components, the interconnect system 1202 may include a PCIe link to carry out the connection. In these examples, a PCI bus need not be included in the computing device 1200.

The memory 1204 may include any of a variety of computer-readable media. The computer-readable media may be any available media that may be accessed by the computing device 1200. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1204 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1200. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1206 may be configured to execute at least some of the computer-readable instructions to control one or more components of the computing device 1200 to perform one or more of the methods and/or processes described herein. The CPU(s) 1206 may each include one or more cores (e.g., one, two, four, eight, twenty-eight, seventy-two, etc.) that are capable of handling a multitude of software threads simultaneously. The CPU(s) 1206 may include any type of processor, and may include different types of processors depending on the type of computing device 1200 implemented (e.g., processors with fewer cores for mobile devices and processors with more cores for servers). For example, depending on the type of computing device 1200, the processor may be an Advanced RISC Machines (ARM) processor implemented using Reduced Instruction Set Computing (RISC) or an x86 processor implemented using Complex Instruction Set Computing (CISC). The computing device 1200 may include one or more CPU(s) 1206 in addition to one or more microprocessors or supplementary co-processors, such as math co-processors.

In addition to or alternatively from the CPU(s) 1206, the GPU(s) 1208 may be configured to execute at least some of the computer-readable instructions to control one or more components of the computing device 1200 to perform one or more of the methods and/or processes described herein. One or more of the GPU(s) 1208 may be an integrated GPU (e.g., with one or more of the CPU(s) 1206 and/or one or more of the GPU(s) 1208 may be a discrete GPU. In embodiments, one or more of the GPU(s) 1208 may be a coprocessor of one or more of the CPU(s) 1206. The GPU(s) 1208 may be used by the computing device 1200 to render graphics (e.g., 3D graphics) or perform general purpose computations. For example, the GPU(s) 1208 may be used for General-Purpose computing on GPUs (GPGPU). The GPU(s) 1208 may include hundreds or thousands of cores that are capable of handling hundreds or thousands of software threads simultaneously. The GPU(s) 1208 may generate pixel data for output images in response to rendering commands (e.g., rendering commands from the CPU(s) 1206 received via a host interface). The GPU(s) 1208 may include graphics memory, such as display memory, for storing pixel data or any other suitable data, such as GPGPU data. The display memory may be included as part of the memory 1204. The GPU(s) 1208 may include two or more GPUs operating in parallel (e.g., via a link). The link may directly connect the GPUs (e.g., using NVLINK) or may connect the GPUs through a switch (e.g., using NVSwitch). When combined together, each GPU 1208 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1206 and/or the GPU(s) 1208, the logic unit(s) 1220 may be configured to execute at least some of the computer-readable instructions to control one or more components of the computing device 1200 to perform one or more of the methods and/or processes described herein. In embodiments, the CPU(s) 1206, the GPU(s) 1208, and/or the logic unit(s) 1220 may discretely or jointly perform any combination of the methods, processes, and/or portions thereof. One or more of the logic unit(s) 1220 may be part of and/or integrated in one or more of the CPU(s) 1206 and/or the GPU(s) 1208 and/or one or more of the logic unit(s) 1220 may be discrete components or otherwise external to the CPU(s) 1206 and/or the GPU(s) 1208. In embodiments, one or more of the logic unit(s) 1220 may be a coprocessor of one or more of the CPU(s) 1206 and/or one or more of the GPU(s) 1208.

Examples of the logic unit(s) 1220 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1210 may include one or more receivers, transmitters, and/or transceivers that allow the computing device 1200 to communicate with other computing devices via an electronic communication network, including wired and/or wireless communications. The communication interface 1210 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1220 and/or communication interface 1210 may include one or more data processing units (DPUs) to transmit data received over a network and/or through interconnect system 1202 directly to (e.g., a memory of) one or more GPU(s) 1208.

The I/O port(s) 1212 may allow the computing device 1200 to be logically coupled to other devices including the I/O components 1214, the presentation component(s) 1218, and/or other components, some of which may be built in to (e.g., integrated in) the computing device 1200. Illustrative I/O components 1214 include a microphone, mouse, keyboard, joystick, game pad, game controller, satellite dish, scanner, printer, wireless device, etc. The I/O components 1214 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1200. The computing device 1200 may include one or more depth cameras, such as stereoscopic camera systems, infrared camera systems, RGB camera systems, touchscreen technology, and combinations of these, for gesture detection and recognition. Additionally, the computing device 1200 may include accelerometers or gyroscopes (e.g., as part of an inertial measurement unit (IMU)) that allow detection of motion. In some examples, the output of the accelerometers or gyroscopes may be used by the computing device 1200 to render immersive augmented reality or virtual reality.

The power supply 1216 may include a hard-wired power supply, a battery power supply, or a combination thereof. The power supply 1216 may provide power to the computing device 1200 to allow the components of the computing device 1200 to operate.

The presentation component(s) 1218 may include a display (e.g., a monitor, a touch screen, a television screen, a heads-up-display (HUD), other display types, or a combination thereof), speakers, and/or other presentation components. The presentation component(s) 1218 may receive data from other components (e.g., the GPU(s) 1208, the CPU(s) 1206, DPUs, etc.), and output the data (e.g., as an image, video, sound, etc.).

### Example Data Center

FIG. 13 illustrates an example data center 1300 that may be used in at least one embodiment of the present disclosure. The data center 1300 may include a data center infrastructure layer 1310, a framework layer 1320, a software layer 1330, and/or an application layer 1340.

As shown in FIG. 13, the data center infrastructure layer 1310 may include a resource orchestrator 1312, grouped computing resources 1314, and node computing resources 1316 (“node C.R.s”), shown as (1)-(N), where “N” represents any whole, positive integer. In at least one embodiment, node computing resources 1316 may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more nodes from among node computing resources 1316 may correspond to a server having one or more of the above-mentioned computing resources. In addition, in some embodiments, the node computing resources 1316 may include one or more virtual components, such as vGPUs, vCPUs, and/or the like, and/or one or more of the node computing resources 916 may correspond to a virtual machine (VM).

In at least one embodiment, grouped computing resources 1314 may include separate groupings of node computing resources 1316 housed within one or more racks (not shown), or many racks housed in data centers at various geographical locations (also not shown). Separate groupings of node computing resources 1316 within grouped computing resources 1314 may include grouped compute, network, memory, or storage resources that may be configured or allocated to support one or more workloads. In at least one embodiment, several node computing resources 1316 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1312 may configure or otherwise control one or more node computing resources 1316 and/or grouped computing resources 1314. In at least one embodiment, resource orchestrator 1312 may include a software design infrastructure (SDI) management entity for the data center 1300. The resource orchestrator 1312 may include hardware, software, or some combination thereof.

In at least one embodiment, as shown in FIG. 13, framework layer 1320 may include a job scheduler 1328, a configuration manager 1334, a resource manager 1336, and/or a distributed file system 1338. The framework layer 1320 may include a framework to support software 1332 of software layer 1330 and/or one or more application(s) 1342 of application layer 1340. The software 1332 or application(s) 1342 may respectively include web-based service software or applications, such as those provided by Amazon Web Services, Google Cloud and Microsoft Azure. The framework layer 1320 may be, but is not limited to, a type of free and open-source software web application framework such as Apache Spark™ (hereinafter “Spark”) that may use distributed file system 1338 for large-scale data processing (e.g., “big data”). In at least one embodiment, job scheduler 1328 may include a Spark driver to facilitate scheduling of workloads supported by various layers of data center 1300. The configuration manager 1334 may be capable of configuring different layers such as software layer 1330 and framework layer 1320 including Spark and distributed file system 1338 for supporting large-scale data processing. The resource manager 1336 may be capable of managing clustered or grouped computing resources mapped to or allocated for support of distributed file system 1338 and job scheduler 1328. In at least one embodiment, clustered or grouped computing resources may include grouped computing resources 1314 at data center infrastructure layer 1310. The resource manager 1336 may coordinate with resource orchestrator 1312 to manage these mapped or allocated computing resources.

In at least one embodiment, software 1332 included in software layer 1330 may include software used by at least portions of node computing resources 1316, grouped computing resources 1314, and/or distributed file system 1338 of framework layer 1320. One or more types of software may include, but are not limited to, Internet web page search software, e-mail virus scan software, database software, and streaming video content software.

In at least one embodiment, application(s) 1342 included in application layer 1340 may include one or more types of applications used by at least portions of node computing resources 1316, grouped computing resources 1314, and/or distributed file system 1338 of framework layer 1320. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1334, resource manager 1336, and resource orchestrator 1312 may implement any number and type of self-modifying actions based on any amount and type of data acquired in any technically feasible fashion. Self-modifying actions may relieve a data center operator of data center 1300 from making possibly bad configuration decisions and possibly avoiding underutilized and/or poor performing portions of a data center.

The data center 1300 may include tools, services, software, or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1300. In at least one embodiment, trained or deployed machine learning models corresponding to one or more neural networks may be used to infer or predict information using resources described above with respect to the data center 1300 by using weight parameters calculated through one or more training techniques, such as but not limited to those described herein.

In at least one embodiment, the data center 1300 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device 1200 of FIG. 12—e.g., each device may include similar components, features, and/or functionality of the computing device 1200. In addition, where backend devices (e.g., servers, NAS, etc.) are implemented, the backend devices may be included as part of a data center 1300, an example of which is described in more detail herein with respect to FIG. 13.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment - and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device 1200 described herein with respect to FIG. 12. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or operations or combinations of steps or operations similar to the ones described in this document, in conjunction with other present or future technologies. Moreover, although the terms “step” and/or “block” and/or “operation” may be used herein to connote different elements of methods employed, the terms should not be interpreted as implying any particular order among or between various steps herein disclosed unless and except when the order of individual steps is explicitly described.

### EXAMPLES

Specific example embodiments are now described. In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is one or more processors comprising processing circuitry to perform operations comprising: monitoring statuses of a set of nodes of a computing cluster; identifying at least one node of the set of nodes for application of at least one modification based on the statuses; causing at least one first label to be applied to the at least one node, wherein the at least one first label prevents new workloads from being scheduled for the at least one node; applying the at least one modification to the at least one node; and causing the at least one first label to be removed from the at least one node based on a completion of the at least one modification, wherein removal of the at least one first label allows the new workloads to be scheduled for the at least one node.

In Example 2, the subject matter of Example 1 comprises wherein monitoring the statuses of the set of nodes comprises: providing at least one query to the computing cluster; and receiving at least one event indicating at least one change to the set of nodes.

In Example 3, the subject matter of Examples 1-2 comprises wherein identifying the at least one node of the set of nodes is based on a software package, the software package comprising a set of labels applicable to the set of nodes, the set of labels comprising at least one of a second label indicating a node is available to modify, a third label indicating the node is assigned an interruptible workload, a fourth label indicating the node is assigned with an uninterruptible workload, or a fifth label indicating the node is modified.

In Example 4, the subject matter of Examples 1-3 comprises wherein identifying the at least one node of the set of nodes is based on a software package, the software package comprising an interruption budget indicating a number of nodes that are removable from scheduling at a time.

In Example 5, the subject matter of Example 4 comprises wherein the number of nodes corresponds to a node type, and the interruption budget comprises a plurality of numbers of nodes corresponding to a plurality of node types.

In Example 6, the subject matter of Examples 1-5 comprises wherein identifying the at least one node of the set of nodes is based on a software package, the software package identifying the at least one modification to be applied and identifying at least one status for the at least one node to allow the application of the at least one modification.

In Example 7, the subject matter of Examples 1-6 comprises wherein identifying the at least one node of the set of nodes is based on a software package, the software package identifying at least one dependency for application of the at least one modification.

In Example 8, the subject matter of Examples 1-7 comprises wherein applying the at least one modification to the at least one node comprises: determining at least one current workload on the at least one node is complete; and removing at least one remaining workload scheduled for the at least one node, wherein the at least one modification is applied to the at least one node subsequent to removing the at least one remaining workload.

In Example 9, the subject matter of Examples 1-8 comprises wherein applying the at least one modification to the at least one node is based on a software package, the software package comprising at least one of a type of interrupt to apply to the at least one node prior to the at least one modification, at least one pre-interrupt instruction to execute prior to interrupting the at least one node, or at least one post-interrupt instruction to execute subsequent to interrupting the at least one node.

In Example 10, the subject matter of Examples 1-9 comprises identifying at least one new node added to the computing cluster based on a notification from a computing manager of the computing cluster; determining the at least one modification is to be applied to the at least one new node based on a software package; causing the at least one first label to be applied to the at least one new node; applying the at least one modification to the at least one new node; and causing the at least one first label to be removed from the at least one new node.

In Example 11, the subject matter of Examples 1-10 comprises determining at least one second modification to uninstall based on a software package; identifying at least one second node that has the at least one second modification based on at least one annotation associated with the at least one second node; causing the at least one first label to be applied to the at least one second node; uninstalling the at least one second modification from the at least one second node; and removing the at least one first label from the at least one second node.

In Example 12, the subject matter of Examples 1-11 comprises wherein the new workloads are scheduled for at least one second node while the at least one modification is applied to the at least one node.

In Example 13, the subject matter of Examples 1-12 comprises wherein the at least one modification comprises an update to an operating system of the at least one node.

Example 14 is a system comprising one or more processors to perform operations comprising: monitoring statuses of a set of nodes of a computing cluster; identifying at least one node of the set of nodes for application of at least one modification based on the statuses; causing at least one first label to be applied the at least one node, wherein the at least one first label prevents new workloads from being scheduled for the at least one node; applying the at least one modification to the at least one node; and causing the at least one first label to be removed from the at least one node based on a completion of the at least one modification, wherein removal of the at least one first label allows the new workloads to be scheduled for the at least one node.

In Example 15, the subject matter of Example 14 comprises wherein monitoring the statuses of the set of nodes comprises: providing at least one query to the computing cluster; and receiving at least one event indicating at least one change to the set of nodes.

In Example 16, the subject matter of Examples 14-15 comprises wherein identifying the at least one node of the set of nodes is based on a software package, the software package comprising a set of labels applicable to the set of nodes, the set of labels comprising at least one of a second label indicating a node is available to modify, a third label indicating the node is assigned an interruptible workload, a fourth label indicating the node is assigned with an uninterruptible workload, or a fifth label indicating the node is modified.

In Example 17, the subject matter of Examples 14-16 comprises wherein identifying the at least one node of the set of nodes is based on a software package, the software package identifying the at least one modification to be applied and identifying at least one status for the at least one node to allow the application of the at least one modification.

In Example 18, the subject matter of Examples 14-17 comprises wherein identifying the at least one node of the set of nodes is based on a software package, the software package identifying at least one dependency for application of the at least one modification.

In Example 19, the subject matter of Examples 14-18 comprises wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for three-dimensional (3D) assets; a system for performing deep learning operations; a system implemented using an edge device; a system implemented using a robot; a system for performing conversational AI operations; a system for performing operations using one or more large language models (LLMs); a system for performing operations using one or more small language models (SLMs); a system for performing operations using one or more vision language models (VLMs); a system for performing operations using one or more multi-modal language models (MMLMs); a system for performing synthetic data generation; a system for generating synthetic data using AI; a system for presenting at least one of virtual reality content, augmented reality content, or mixed reality content; a system incorporating one or more virtual machines (VMs); a system using or deploying one or more inference microservices; a system that incorporates one or more machine learning models deployed in a service or microservice along with an OS-level virtualization package; a system implemented at least partially in a data center; or a system implemented at least partially using cloud computing resources.

Example 20 is a method comprising: monitoring statuses of a set of nodes of a computing cluster; identifying at least one node of the set of nodes for application of at least one modification based on the statuses; causing at least one first label to be applied to the at least one node, wherein the at least one first label prevents new workloads from being scheduled for the at least one node; applying the at least one modification to the at least one node; and causing the at least one first label to be removed from the at least one node based on a completion of the at least one modification, wherein removal of the at least one first label allows the new workloads to be scheduled for the at least one node.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

What is claimed is:

1. One or more processors comprising processing circuitry to perform operations comprising:
monitoring statuses of a set of nodes of a computing cluster;
identifying at least one node of the set of nodes for application of at least one modification based on the statuses;
causing at least one first label to be applied to the at least one node, wherein the at least one first label prevents new workloads from being scheduled for the at least one node;
applying the at least one modification to the at least one node; and
causing the at least one first label to be removed from the at least one node based on a completion of the at least one modification, wherein removal of the at least one first label allows the new workloads to be scheduled for the at least one node.

2. The one or more processors of claim 1, wherein monitoring the statuses of the set of nodes comprises:
providing at least one query to the computing cluster; and
receiving at least one event indicating at least one change to the set of nodes.

3. The one or more processors of claim 1, wherein identifying the at least one node of the set of nodes is based on a software package, the software package comprising a set of labels applicable to the set of nodes, the set of labels comprising at least one of a second label indicating a node is available to modify, a third label indicating the node is assigned an interruptible workload, a fourth label indicating the node is assigned with an uninterruptible workload, or a fifth label indicating the node is modified.

4. The one or more processors of claim 1, wherein identifying the at least one node of the set of nodes is based on a software package, the software package comprising an interruption budget indicating a number of nodes that are removable from scheduling at a time.

5. The one or more processors of claim 4, wherein the number of nodes corresponds to a node type, and the interruption budget comprises a plurality of numbers of nodes corresponding to a plurality of node types.

6. The one or more processors of claim 1, wherein identifying the at least one node of the set of nodes is based on a software package, the software package identifying the at least one modification to be applied and identifying at least one status for the at least one node to allow the application of the at least one modification.

7. The one or more processors of claim 1, wherein identifying the at least one node of the set of nodes is based on a software package, the software package identifying at least one dependency for application of the at least one modification.

8. The one or more processors of claim 1, wherein applying the at least one modification to the at least one node comprises:
determining at least one current workload on the at least one node is complete; and
removing at least one remaining workload scheduled for the at least one node, wherein the at least one modification is applied to the at least one node subsequent to removing the at least one remaining workload.

9. The one or more processors of claim 1, wherein applying the at least one modification to the at least one node is based on a software package, the software package comprising at least one of a type of interrupt to apply to the at least one node prior to the at least one modification, at least one pre-interrupt instruction to execute prior to interrupting the at least one node, or at least one post-interrupt instruction to execute subsequent to interrupting the at least one node.

10. The one or more processors of claim 1, the operations further comprising:
identifying at least one new node added to the computing cluster based on a notification from a computing manager of the computing cluster;
determining the at least one modification is to be applied to the at least one new node based on a software package;
causing the at least one first label to be applied to the at least one new node;
applying the at least one modification to the at least one new node; and
causing the at least one first label to be removed from the at least one new node.

11. The one or more processors of claim 1, the operations further comprising:
determining at least one second modification to uninstall based on a software package;
identifying at least one second node that has the at least one second modification based on at least one annotation associated with the at least one second node;
causing the at least one first label to be applied to the at least one second node;
uninstalling the at least one second modification from the at least one second node; and
causing the at least one first label to be removed from the at least one second node.

12. The one or more processors of claim 1, wherein the new workloads are scheduled for at least one second node while the at least one modification is applied to the at least one node.

13. The one or more processors of claim 1, wherein the at least one modification comprises an update to an operating system of the at least one node.

14. A system comprising one or more processors to perform operations comprising:
monitoring statuses of a set of nodes of a computing cluster;
identifying at least one node of the set of nodes for application of at least one modification based on the statuses;
causing at least one first label to be applied to the at least one node, wherein the at least one first label prevents new workloads from being scheduled for the at least one node;
applying the at least one modification to the at least one node; and
causing the at least one first label to be removed from the at least one node based on a completion of the at least one modification, wherein removal of the at least one first label allows the new workloads to be scheduled for the at least one node.

15. The system of claim 14, wherein monitoring the statuses of the set of nodes comprises:
providing at least one query to the computing cluster; and
receiving at least one event indicating at least one change to the set of nodes.

16. The system of claim 14, wherein identifying the at least one node of the set of nodes is based on a software package, the software package comprising a set of labels applicable to the set of nodes, the set of labels comprising at least one of a second label indicating a node is available to modify, a third label indicating the node is assigned an interruptible workload, a fourth label indicating the node is assigned with an uninterruptible workload, or a fifth label indicating the node is modified.

17. The system of claim 14, wherein identifying the at least one node of the set of nodes is based on a software package, the software package identifying the at least one modification to be applied and identifying at least one status for the at least one node to allow the application of the at least one modification.

18. The system of claim 14, wherein identifying the at least one node of the set of nodes is based on a software package, the software package identifying at least one dependency for application of the at least one modification.

19. The system of claim 14, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system implemented using an edge device;
a system implemented using a robot;
a system for performing conversational AI operations;
a system for performing operations using one or more large language models (LLMs);
a system for performing operations using one or more small language models (SLMs);
a system for performing operations using one or more vision language models (VLMs);
a system for performing operations using one or more multi-modal language models (MMLMs);
a system for performing synthetic data generation;
a system for generating synthetic data using AI;
a system for presenting at least one of virtual reality content, augmented reality content, or mixed reality content;
a system incorporating one or more virtual machines (VMs);
a system using or deploying one or more inference microservices;
a system that incorporates one or more machine learning models deployed in a service or microservice along with an OS-level virtualization package;
a system implemented at least partially in a data center; or
a system implemented at least partially using cloud computing resources.

20. A method comprising:
monitoring statuses of a set of nodes of a computing cluster;
identifying at least one node of the set of nodes for application of at least one modification based on the statuses;
causing at least one first label to be applied to the at least one node, wherein the at least one first label prevents new workloads from being scheduled for the at least one node;
applying the at least one modification to the at least one node; and
causing the at least one first label to be removed from the at least one node based on a completion of the at least one modification, wherein removal of the at least one first label allows the new workloads to be scheduled for the at least one node.
